(19) United States
(12) Patent Application Publication
(10) Pub. No.: US 2007/0207890 A1
(43) Pub. Date: Sep. 6, 2007

(54) Automatic transmission and method of assembling the transmission

(76) Inventor: Sergei S. Penksik, Wombourne (GB)

Correspondence Address: Caterpillar Inc.;Intellectual Property Dept., AB 6490, 100 N.E. Adams Street, PEORIA, IL, 61629-6490, US

(21) Appl. No.: 11/365,436

(22) Filed: Mar. 1, 2006

(51) Int. Cl. F16H 3/62

(52) U.S. Cl. 475/275

(57) ABSTRACT

A transmission includes a plurality of rotating clutches and brakes and first, second, and third planetary gear sets. Each planetary gear set includes a sun gear, planet gears, and ring gears. Ring gears of the first and second planetary gear sets are permanently connected and include a circumferential protrusion extending from an outer surfer to an inner surface of the transmission. Brake housings, fastened together, create a channel there between adapted to receive the circumferential protrusion. The channel includes tabbed thrust washers positioned on both sides of the circumferential protrusion. The transmission is assembled with the circumferential protrusion placed within a channel between adjacent brake housings.

### TECHNICAL FIELD

The present invention relates to transmissions and, more particularly, to gears for an automatic transmission.

### BACKGROUND

Most mobile vehicles are driven by an engine, which is coupled to a transmission. Mechanical energy from the engine is transferred to the transmission and ultimately to driven elements, such as wheels or tracks. The transmission may have a plurality of torque transmitting paths, which may be automatically selected through a control module, or manually selected by an operator.

The transmission is adapted to fit between frame rails of the vehicle, and often times positioned below a cab of the vehicle. Vehicles known to use automatic transmissions have tight constraints due to the large size of the engine, the large size of the transmission, distance between the frame rails, exhaust routing pipes, and suspension and steering components.

U.S. Pat. No. 3,996,817 to Winzeler, and assigned to Caterpillar, teaches a transmission that shares internal walls between adjacent clutches and brakes. The sharing of walls decreases the length of the transmission to allow it to fit within certain machines. Due to the orientation of the planetary gear sets and clutch and brake assemblies, the transmission may be too large diametrically to fit within some machines.

The present invention is directed to overcoming one or more of the problems as set forth above.

### SUMMARY OF THE INVENTION

In one exemplary aspect of the present invention, a ring gear for a transmission is provided. The ring gear includes an inner surface and an outer surface, a first set of gear teeth protruding from the inner surface, a second set of gear teeth protruding from the inner surface, and a protrusion extending from the outer surface of the ring gear.

According to another aspect, a transmission is provided. The transmission includes a transmission housing, an input member, and at least one planetary gear set. The planetary gear set drivably connects to the input member and includes a sun gear, at least one planet gear, and a ring gear. A protrusion extends from the ring gear. A brake housing attached to the transmission housing includes a channel and the protrusion extends into the channel.

According to yet another aspect, another embodiment of a transmission is provided. The transmission includes a transmission housing, an input member and first and second planetary gear sets. The planetary gear sets drivably connect to the input member. Each of the first and second planetary gear sets includes a sun gear, at least one planet gear, and a ring gear. The ring gears are directly connected to each other. A protrusion extends from the connected ring gears. First and second brake housings attach to the transmission housing to form a channel there between. The protrusion extends into the channel.

According to still another embodiment, a method of assembly a transmission is provided. The transmission includes a transmission housing, an input member and first and second planetary gear sets. The planetary gear sets drivably connect to the input member. Each of the first and second planetary gear sets includes a sun gear, at least one planet gear, and a ring gear. The ring gears are directly connected to each other. A protrusion extends from the connected ring gears. First and second brake housings attach to the transmission housing to form a channel there between. The protrusion extends into the channel. The method includes the steps of fastening one of the first or second brake housings to the transmission housing, positioning the protrusion adjacent the one of the first or second brake housing, and fastening the other of the first or second brake housings to the transmission housing, to form a channel around the protrusion.

It is to be understood that both the foregoing general description and the following detailed description are exemplary and explanatory only and are not restrictive of the invention.

### BRIEF DESCRIPTION OF THE DRAWINGS

FIG. 1 is a side view of a vehicle according to one embodiment of the present invention;

FIG. 2 is a schematic view of a transmission according to one embodiment of the present disclosure;

FIG. 3 is a cross-sectional view of a transmission according to one embodiment of the present disclosure;

FIG. 4 is an isometric view of a ring gear according to one embodiment of the present disclosure; and

FIG. 5 is an isometric view of a ring gear and first and second brake housings according to one embodiment of the present disclosure.

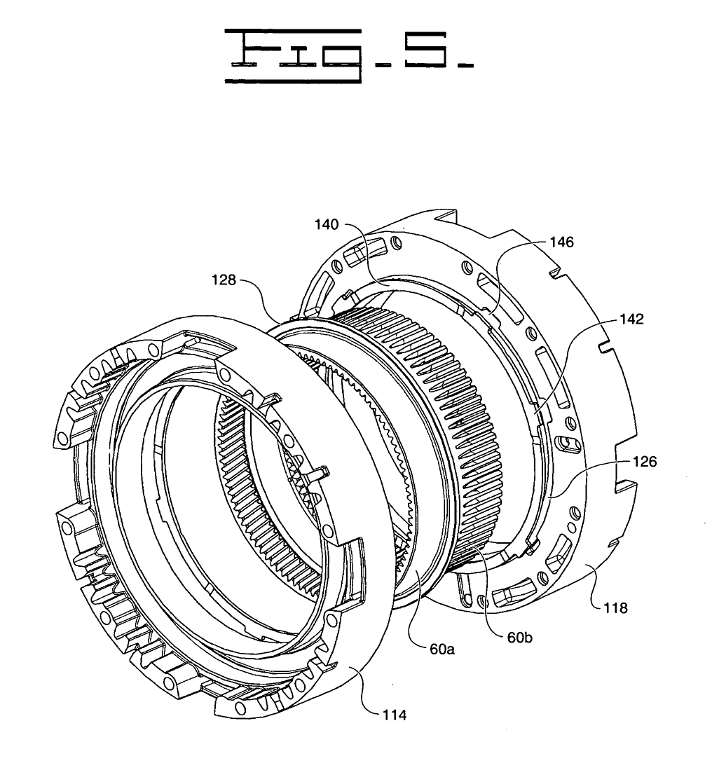

### DETAILED DESCRIPTION

Reference will now be made in detail to embodiments of the invention, examples of which are illustrated in the accompanying drawings.

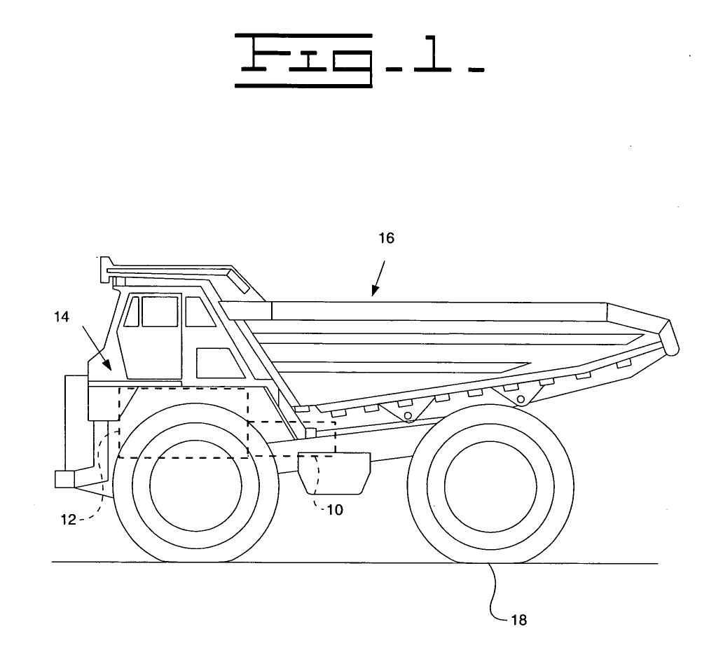

FIG. 1 illustrates a vehicle with a transmission 10 and an engine 12. The engine 12 may be, for example, an internal combustion engine 12 or any other type of engine 12 known in the art. The engine 12 and the transmission 10 may be mounted within an engine compartment 14 of a work machine 16 and may be configured to supply power to driving elements 18, e.g., wheels, tires, or tracks, of the work machine 16 by any conventional means.

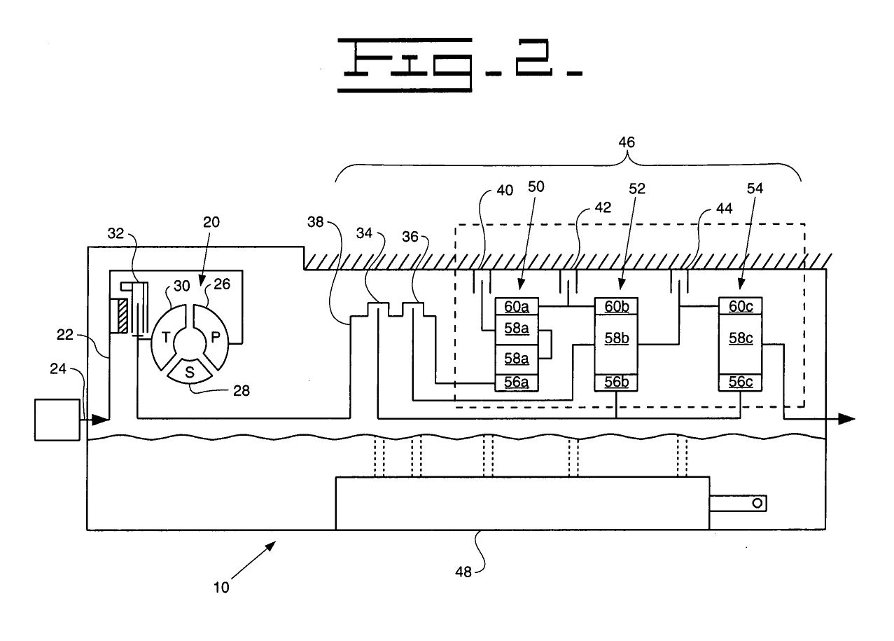

Referring to FIG. 2, the transmission 10 may be connected to the engine 12 through any conventional means, such as a torque converter 20. The torque converter 20 includes a rotatable housing 22 coupled with the engine 12 through the engine's output member 24. The rotatable housing 22 is directly connected to an impeller 26. The torque converter 20 also includes a stator member 28 and a turbine element 30 arranged within the housing 22, and a lock-up clutch 32.

The lock-up clutch 32 operates to directly couple the output member 24 of the engine 12 to the transmission 10, or disengage, to provide a fluid coupling between the engine 12 and the transmission 10. The lock-up clutch 32 may be selectively engaged to provide more efficient operation at relatively high speeds or selectively disengaged at low speed, between shifts, and/or high torque conditions.

The transmission 10 includes first and second hydraulically actuated rotatable clutches 34, 36 within a rotatable housing 38, and first, second, and third hydraulically actuated brakes 40, 42, 44. The terms “clutch” and “brake” may be used interchangeably. Collectively, the clutches 34, 36 and brakes, 40, 42, 44 will be referred to as friction devices 46. Each of the friction devices 46 may be selectively actuated or engaged by a transmission control module 48. The transmission control module 48 communicates with each of the friction devices 46 through corresponding fluid passages. A pump (not shown) provides pressurized fluid to control valves, which modulate the fluid to selected friction devices 46.

The transmission 10 further includes a plurality of planetary gear sets 50, 52, 54. Each of the planetary gear sets 50, 52, 54 includes a sun gear 56, planet gears 58, and a ring gear 60. The sun gears of the first, second, and third planetary gear sets 50, 52, 54, may be referred independently as 56a, 56b, and 56c respectively. Similarly, the planet gears of the first, second, and third planetary gear sets may be referred to independently as 58a, 58b, and 58c respectively. Likewise, the ring gears of the first, second, and third planetary gear sets 50, 52, 54 may be referred to independently as 60a, 60b, and 60c respectively. The planetary gear sets 50, 52, 54 may comprise simple planet gear units having single pinions or compound pinions. As is known in the art, the sun gears 56 of each of the planet gear sets 50, 52, 54 engage the planet gears 58, which engage the ring gears 60. Carriers may be used to connect the planet gears 58 to any other member of other planetary gear sets 50, 52, 54.

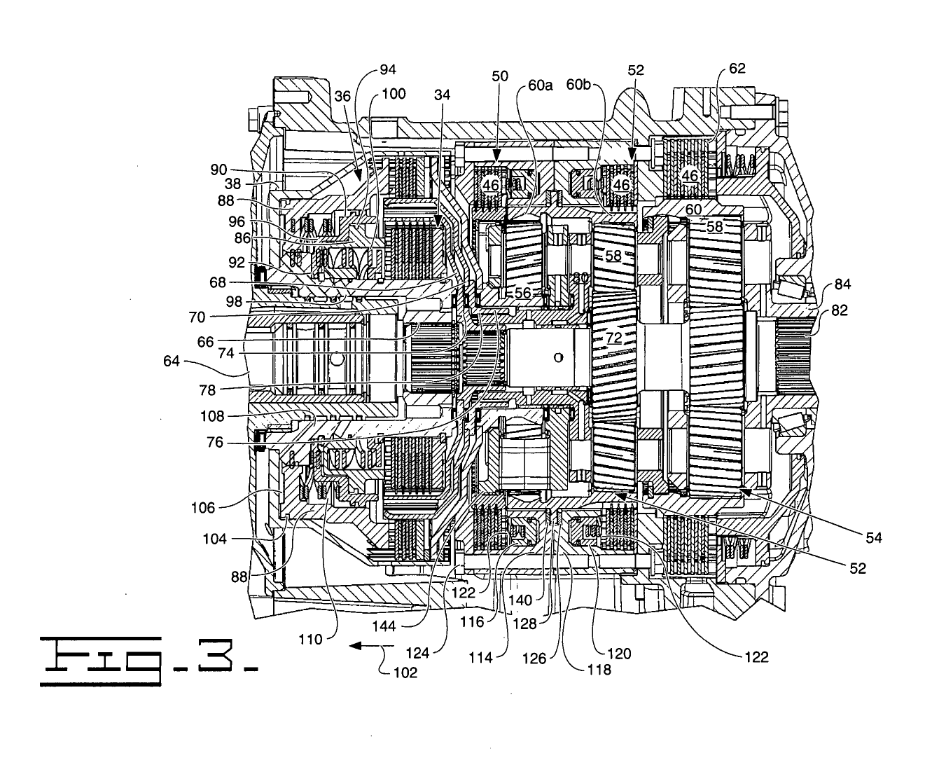

FIG. 3 illustrates a cross-sectional view of the transmission 10. Referring specifically at the friction devices 46, each friction device 46 includes a plurality of discs 62 operable to engage to transmit power from the engine 12 (See FIG. 1) through a desired torque path. The first rotating clutch 34 is positioned between the second rotating clutch 36 and a transmission input member 64 within the clutch housing. The rotatable housing 38 connects to the input member 64 through a spline fitting 66 and transmits power to the sun gear 56 of the first planetary gear set 50.

Each of the first and second rotatable clutches 34, 36 may be selectively engaged to couple the rotatable housing 38 to a corresponding first or second power transmitting member 68, 70. The first power transmitting member 68 receives power from the input member 64 through the first rotating clutch 34, when engaged, and transmits the power to a first intermediate drive member 72 through a splined connection 74. The second power transmitting member 70 receives power from the input member 64 through the second rotating clutch 36, when engaged, and transmits power to a second intermediate drive member 76 through a splined connection 78.

The first and second intermediate drive members 72, 76 extend into the transmission 10. Specifically, the first intermediate drive member 72 extends through each of the first, second, and third planetary gear sets 50, 52, 54 to drivingly engage the sun gears 56 of the second and third planetary gear sets 52, 54. The sun gears 56 may be splined to the shaft or fully integrated thereto. The second intermediate drive member 76 extends through the first planetary gear set 50 and engages a carrier assembly 80 of the second planetary gear set 52.

The first brake 40 may selectively engage the planet gears 58 of the first planetary gear set 50. The ring gears 60 of the first and second planetary gear sets 50, 52 are permanently connected to each other and may be selectively engaged by the second brake 42. Similarly, the planet gears 58 of the second planetary gear 52 set may be permanently connected, by means of the carrier assembly 80, to the ring gear 60 of the third planetary gear set 54, which may be selectively engaged by the third brake 44. The planet gears 58 of the third planetary gear set 54 may be splined to a transmission output member 82 by means of a carrier assembly 84. The transmission output member 82 provides power to the driven elements 18, tracks, or wheels (See FIG. 1).

Each of the first and second clutch assemblies 34, 36 includes first and second pistons 86, 88, respectively. A wall 90 separates the first and second pistons 86, 88. The wall 90 directly connects to an inner portion 92 of the rotatable housing 38. Seals 94 positioned on the first piston 86 create a sealed cavity 96 between the wall 90 and the first piston 86. A fluid passage 98 allows pressurized fluid to fill the cavity 96 to move the first piston 86 to engage the first rotatable clutch 34. The fluid provided to the fluid passage 98 is controlled through a control valve (not shown), which is electronically actuated with a control module (not shown) and power source (not shown). Retraction springs 100 provide a biasing force in direction of arrow 102 to push the piston 86 to a disengaged position when fluid is shut off from the cavity 96.

Similarly, seals 104 create a sealed cavity 106 between the clutch housing 38 and the second piston 88. A fluid passage 108 allows pressurized fluid to fill the cavity 106 to press the second piston 88 to engage the second clutch 36. Retraction springs 110 provide a biasing force in direction of arrow 102 to push the piston 88 to a disengaged position when fluid is shut off from the cavity 106.

The retraction springs 100, 110 may be coiled or wave springs, or any type of disengaging device known in the art. Similarly, the springs 100, 110 may be replaced with additional fluid passages to provide fluid to additional cavities to provide a disengaging force.

The first intermediate drive member 72 transmits power from the first transmitting member 68 through fully integrated sun gears 56 of the second and third planetary gear sets 52, 54.

A first brake housing 114 includes a piston 116 in sliding engagement with the first brake housing 114 and operates to move from a disengaged position to an engaged position. In the engaged position, the first brake 40 locks the carrier assembly 80 of the first planetary gear set 50 in a stationary position. A second brake housing 118 includes a piston 120 in sliding engagement with the second brake housing 118 and operates to move from a disengaged position to an engaged position. As discussed above, the ring gear 60 of the first planetary gear set 50 directly connects to the ring gear 60 of the second planetary gear set 52. Accordingly, when the piston 120 of the second brake housing 118 is in an engaged position, the ring gears 60 of the first and second planetary gear sets 50, 52 are held in a stationary position. Because the ring gear 60 of the first planetary gear set 50 directly connects to the ring gear 60 of the second planetary gear set 52, engagement of the second brake 42 locks the ring gears 60 in a stationary position.

The pistons 116, 120 of the first and second brake housings 114, 118 may be retracted to the disengaged position through the use of retraction springs 122, which may be coil springs or wave springs, or any other known means for retracting the springs, such as hydraulic pressure.

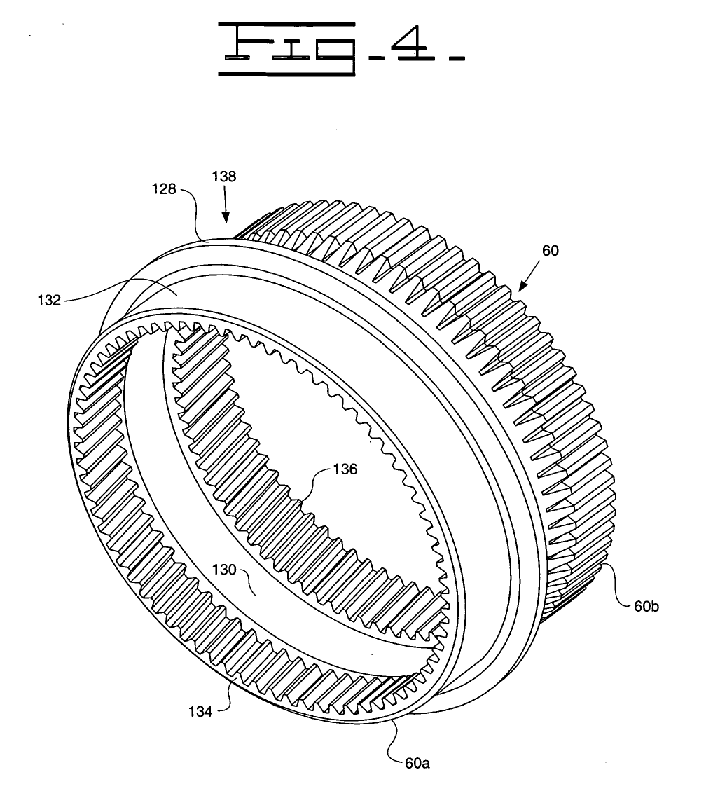

The first brake housing 114 is fastened to the second brake housing 118 through a bolt 124. The second brake housing 118 is fastened directly to the transmission housing through a bolt 124. The first and second brake housings 116, 118 define therein between a groove 126, channel, or cavity adapted to receive a circumferential protrusion 128. Referring to FIG. 4, the ring gear 60 includes an inner 130 and outer surface 132. At least two sets of gear teeth 134, 136 extend inwardly from the inner surface 130 and are axially spaced apart. The protrusion 128 extends circumferentially around the outer surface 132 of the ring gear 60, generally in a central portion 138 thereof.

Within the transmission 10, the protrusion 128 extends into the groove 126 created by the connection of the first and second brake housings 114, 118. Thrust washers 140 are positioned on each side of the ring gear 60 and absorb thrust acting on the ring gear 60 when power is transferred there through. Each thrust washer 140 includes protrusions 142, or tabs that extend into cavities 146, or pockets within each of the first and second brake housings 114, 118 to prevent the thrust washers 140 from rotating. In the illustrated embodiment, the thrust washers 140 include approximately six tabs each.

### INDUSTRIAL APPLICABILITY

The transmission 10 of the type disclosed in the present invention may used to provide propulsion or workable power to a vehicle, or other work machine 16.

To achieve first gear, the first rotatable clutch 34 and the third brake 44 engage. With these friction devices 46 engaged, the carrier assembly 80 for the second planetary gear set 52 and the ring gear 60 for the third planetary gear set 54 are locked against rotation. Similarly, when the first rotating clutch 34 is engaged, the first intermediate drive member 72 directly couples the sun gears 60 of the second and third planetary gear sets 52, 54. Under these conditions, a single torque transmission path is provided through the first power transmitting member 68 and first intermediate drive member 72 through the third planetary gear set 54. With the ring gear 60 of the third planetary gear set 54 being grounded, rotation of the sun gear 56 causes rotation of the carrier assembly 84, which transfers power directly to the transmission output member 82.

When the transmission 10 is shifted from first gear forward to second gear forward, the first rotating clutch 34 remains engaged and the third brake 44 disengages while the second brake 42 simultaneously engages. Resultantly, the ring gears 60 of the first and second planetary gear sets 50, 52 are locked against rotation.

Under these conditions, a split torque transmission path is provided from the first intermediate drive member 72 through the second and third sun gears 56b, 56c. With the second ring gear 60b grounded, rotation of the second sun gear 56b causes rotation of the second carrier assembly 80, which transfers power through the third ring gear 60c. Accordingly, both the third ring gear 60c and the third sun gear 56c provide power to the third carrier 84 assembly to provide power to the transmission output member 82.

When the transmission 10 shifts from second speed forward to third speed forward, the first rotating clutch 34 remains engaged, the second brake 42 disengages and the first brake 40 simultaneously engages. Accordingly, only a first carrier assembly 144 is locked against rotation.

Under these conditions, input torque is delivered to the first sun gear 56a and through the first intermediate drive member 72 directly to the second and third sun gears 56b, 56c. Torque passes from the first sun gear 56a through the first ring gear 60a into the second planetary gear set 52. This torque from the first ring gear 60a is additive, or combines with the torque from the second sun gear 56a. The combined torque transfers through the second carrier assembly 84 to the third ring gear 60c. Similarly, torque from the third sun gear 56c combines with the combined torque from the third ring gear 60c to output through the transmission output member 82.

When the transmission 10 shifts from third speed forward to fourth speed forward, the first brake 40 disengages and the second rotating clutch 36 simultaneously engages. Under these conditions, input torque is delivered through the first and second intermediate drive members 72, 76. All members of the planetary gear sets 50, 52, 54 rotate at the same output speed. Output speed and torque through output member 82 is equal to input speed and torque (direct drive).

When the transmission 10 shifts from fourth speed forward to fifth speed forward, the second rotating clutch 36 remains engaged and the first rotating clutch 34 disengages simultaneous to the engagement of the first brake 40.

When the transmission 10 shifts from fifth speed forward to sixth speed forward, the first brake 40 disengages simultaneous to the engagement of the second brake 42.

While in reverse gears the rotating clutches 34, 36 disengage and the first and third brakes 40, 44 engage. Torque is transmitted through the first sun gear 56a and first and second ring gears 60a, 60b, through the second planetary gear set 52 to the third sun gear 56c and out the transmission output member 84.

It will be apparent to those skilled in the art that various modifications and variations can be made without departing from the scope or spirit of the invention. Other embodiments of the invention will be apparent to those skilled in the art from consideration of the specification and practice of the invention disclosed herein. It is intended that the specification and examples be considered as exemplary only.

What is claimed is:

1. A ring gear, comprising:
an inner surface and an outer surface;
a first set of gear teeth protruding from the inner surface;
a second set of gear teeth protruding from the inner surface; and
a protrusion extending from the outer surface of the ring gear.

2. The ring gear according to claim 1, wherein the first and second set of gear teeth are axially spaced.

3. The ring gear according to claim 1, wherein the protrusion extends circumferentially around the outer surface.

4. The ring gear according to claim 1, wherein the first set of gear teeth is positioned radially outward with respect to the second set of gear teeth.

5. The ring gear according to claim 1 wherein the protrusion extends circumferentially around the outer surface of a central portion of the ring gear.

6. A transmission, comprising:
a transmission housing;
an input member;
at least one planetary gear set drivably connected to the input member and including a sun gear, at least one planet gear, and a ring gear;
a protrusion extending from the ring gear; and
a brake housing attached to the transmission housing and having a channel;
wherein the protrusion extends into the channel.

7. The transmission according to claim 6, wherein the channel runs perpendicular to a center axis of the transmission.

8. The transmission according to claim 6, wherein the channel includes at least one thrust washer between a wall of the protrusion and a wall of the channel.

9. The transmission according to claim 8, wherein the channel includes a thrust washer on each side of the protrusion.

10. The transmission according to claim 9, wherein the channel includes at least one pocket and each of the thrust washers include at least one tab positioned within the at least one pocket.

11. The transmission according to claim 6, wherein the brake housing is fastened to the transmission housing through a bolt.

12. The transmission according to claim 6, wherein the brake housing includes a brake, which is movable from a disengaged position to an engaged position.

13. A transmission, comprising:
a transmission housing;
an input member;
a first and second planetary gear set drivably connected to the input member, wherein each of the first and second planetary gear sets include a sun gear, at least one planet gear, and a ring gear, and wherein the ring gears are directly connected to each other;
a protrusion extending from the connected ring gears; and
first and second brake housings attached to the transmission housing and having a channel formed there between;
wherein the protrusion extends into the channel.

14. The transmission according to claim 13, wherein the channel runs perpendicular to a center axis of the transmission.

15. The transmission according to claim 13, wherein the channel includes at least one thrust washer between a wall of the protrusion and a wall of the channel.

16. The transmission according to claim 15, further comprising a thrust washer on each side of the protrusion.

17. The transmission according to claim 16, wherein the channel includes at least one pocket and each of the thrust washers include at least one tab positioned within the at least one pocket.

18. The transmission according to claim 13, wherein at least one of the first and second brake housings is fastened to the transmission housing through a bolt.

19. The transmission according to claim 13, wherein each of the first and second brake housings includes brakes, which are movable from disengaged positions to engaged positions.

20. A method of assembling a transmission with an input member, first and second planetary gear sets drivably connected to the input member, wherein each of the first and second planetary gear sets include a sun gear, at least one planet gear, and a ring gear, and wherein the ring gears are directly connected to each other, a protrusion extending from the connected ring gears and first and second brake housings attached to the transmission housing and having a channel formed there between, wherein the protrusion extends into the channel, the method comprising the steps of:
fastening one of the first or second brake housings to the transmission housing;
positioning the protrusion adjacent the one of the first or second brake housing; and
fastening the other of the first or second brake housings to the transmission housing, to form a channel around the protrusion.

21. The method according to claim 20, before the positioning step, further comprising the step of placing a thrust washer within a channel of the one of the first or second brake housings.

22. The method according to claim 21, after the positioning step, further comprising the step of placing a second thrust washer adjacent the protrusion on opposite side of the other thrust washer.
